(19) United States
(12) Patent Application Publication
(10) Pub. No.: US 2012/0278237 A1
(43) Pub. Date: Nov. 1, 2012

(54) Method, System and Mobile Device for Distributing Gift Certificate

(75) Inventors: Jae Jun Lee, Seoul (KR); Ki Wan Park, Seoul (KR); Jong Hwa Han, Seongnam-si (KR)

(73) Assignee: ICONLAB INC.

(21) Appl. No.: 13/457,745

(22) Filed: Apr. 27, 2012

(30) Foreign Application Priority Data
Apr. 29, 2011 (KR) 10-2011-0040641

(51) Int. Cl. G06Q 20/34; G06Q 20/40

(52) U.S. Cl. 705/44; 705/39

(57) ABSTRACT

A method for distributing a gift certificate may be provided that includes: receiving information on an affiliate identifier recognized by a user terminal device; receiving payment information of a user of the user terminal device from an affiliate terminal device; and calculating a remaining amount of the gift certificate of the user or a mileage of the user on the basis of the payment information.

### BACKGROUND

1. Field

The present invention relates to a method, a system and a mobile device for distributing a gift certificate, and more particularly to a method, a system and a mobile device, all of which permit a user to purchase and pay for goods through identifier recognition.

2. Description of Related Art

Recently, as various commercial activities are actively increased, numerous gift certificates are being distributed. For example, there are many kinds of gift certificates which are now being distributed, such as a department store gift certificate, a shoe gift certificate, an education gift certificate, a meal gift certificate, a gas supply gift certificate, a sightseeing gift certificate, a book gift certificate, a culture gift certificate, a mobile gift certificate and the like. At present, a paper gift certificate issued by a distribution company and a card gift certificate issued by a financial company are widely distributed. A distribution system for such gift certificates requires an issuance cost and the like. The gift certificate can be purchased only by visiting a place where the gift certificate is sold. If one does not carry the gift certificate, he/she is not able to use the gift certificate despite a fact that he/she has purchased it.

In the mean time, with the development of electronic communication devices, most people have a personal mobile terminal Recently, active researches are now being done to a smart phone which allows a user to install his/her favorite applications therein. The smart phone is a kind of an intelligent terminal which is formed by adding a computer supporting function such as an Internet communication, information search and the like to the mobile terminal.

Therefore, it is true that there is an urgent demand for a technical development which allows the gift certificate to be distributed and used by using the smart phone rapidly spreading through the world, so that people are able to easily purchase and use the gift certificate anytime and anywhere.

### SUMMARY

One embodiment of the present invention is a method for distributing a gift certificate. The method includes: receiving recognition information on an identifier, which includes affiliate identification information or goods purchase information, from a user mobile terminal; performing payment on the basis of the received information; and transmitting payment completion information to the user mobile terminal or an affiliate terminal device.

Another embodiment of the present invention is a method for distributing a gift certificate. The method includes: an identifier information receiver receiving recognition information on an identifier, which includes affiliate identification information or goods purchase information, from a user mobile terminal; and a payment performer performing payment on the basis of the received information and transmitting payment completion information to the user mobile terminal or an affiliate terminal device.

Further another embodiment of the present invention is a mobile terminal. The mobile terminal includes: an identifier recognizer which recognizes an identifier including affiliate identification information or goods purchase information and transmits the recognized information; and an application driver which activates the identifier recognizer and drives an application completing payment based on the transmitted information.

According to the one embodiment of the present invention provides another method for distributing a gift certificate and a computer-readable recording medium which records a computer program for executing the method.

### BRIEF DESCRIPTION OF THE DRAWINGS

FIG. 1 is a view schematically showing an entire configuration of a gift certificate distribution system according to an embodiment of the present invention;

FIG. 2a is a view showing a detailed configuration of the gift certificate distribution system according to the one embodiment of the present invention;

FIG. 2b is a view showing a detailed configuration of a payment performer according to the one embodiment of the present invention; and

FIG. 3 is a view showing a detailed configuration of a user terminal device according to the one embodiment of the present invention.

### DETAILED DESCRIPTION

The following detailed description of the present invention shows a specified embodiment of the present invention and will be provided with reference to the accompanying drawings. The embodiment will be described in enough detail that those skilled in the art are able to embody the present invention. It should be understood that various embodiments of the present invention are different from each other and need not be mutually exclusive. For example, a specific shape, structure and properties, which are described in this disclosure, may be implemented in other embodiments without departing from the spirit and scope of the present invention with respect to one embodiment. Also, it should be noted that positions or placements of individual components within each disclosed embodiment may be changed without departing from the spirit and scope of the present invention. Therefore, the following detailed description is not intended to be limited. If adequately described, the scope of the present invention is limited only by the appended claims of the present invention as well as all equivalents thereto. Similar reference numerals in the drawings designate the same or similar functions in many aspects.

Hereafter, in order to allow those skilled in the art to easily embody the present invention, exemplary embodiments of the present invention will be described in detail with reference to the accompanying drawings.

### AN EXEMPLARY EMBODIMENT OF THE PRESENT INVENTION

A “gift certificate” of the present invention is an available thing that can be used instead of cash to purchase articles or use services at a predetermined affiliate. The gift certificate includes a mileage card which can be used in lieu of cash by mileages accumulated through the article purchase, the service use and the like. The gift certificate should be understood as a general term which means all kinds of securities (for example, a coupon, a gifticon and the like) which have a predetermined face value and are used as a trade means in substitution for cash.

“Goods” of the present invention means all of tangible and intangible goods to be subjects of sale. The goods may include not only articles but also web contents such as a moving picture, music, a game software and the like. The goods should be understood as a general concept of a coupon, a gift certificate, a gifticon and an identification code and the like, all of which can be exchanged for other articles or service.

### Configuration of Entire System

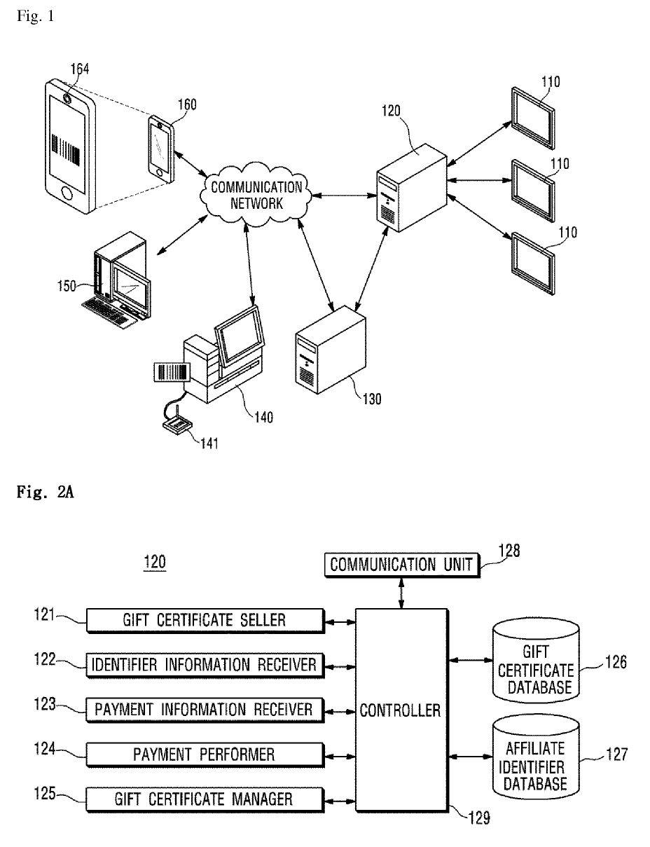

FIG. 1 is a view schematically showing a configuration of an entire system for distributing a mobile gift certificate in accordance with one embodiment of the present invention.

As shown in FIG. 1, the entire system of the present invention may include a communication network 100, a gift certificate issuer terminal device 110, a gift certificate distribution system 120, a value added network (VAN) server 130, an affiliate terminal device 140, a user terminal device 150 and a user mobile terminal 160.

First, the communication network 100 may be configured with various communication networks, for example, a local area network (LAN), a metropolitan area network (MAN), a wide area network (WAN) and the like, regardless of a communication pattern such as a wired or wireless communication and the like. Preferably, the communication network 100 of the present invention may be a well-known world wide web (WWW). Meanwhile, a communication network used for communication between the affiliate terminal device 140 and the VAN server 130 may be a communication network different from a communication network used for communication between other devices (for example, communication between the user mobile terminal 160 and the gift certificate distribution system 120). However, the term of the “communication network 100” will be used as a meaning including all kinds of communication networks for the sake of convenience of description.

The gift certificate issuer terminal device 110 according to the one embodiment of the present invention provides a variety of gift certificate information to the gift certificate distribution system 120 and issues a gift certificate to be purchased by a user. An owner of the gift certificate issuer may access the gift certificate distribution system 120 through the gift certificate issuer terminal device 110 and inquiry the sales of the gift certificate provided by himself or herself, and provide gift certificates already sold and new gift certificates, and the like. A payment for the gift certificate issued by the gift certificate issuer may be performed by the gift certificate distribution system 120, and various well-known methods can be used for the payment. The gift certificate issuer terminal device 110 is disposed in the gift certificate issuer. One or more terminal devices 110 are capable of communicating with the gift certificate distribution system 120.

The terminal device 110 allows the owner of the gift certificate issuer to access and communicate with the gift certificate distribution system 120. Any digital device, such as a personal computer (e.g., a desk top computer, a notebook computer, etc.), a workstation, a PDA, a web pad, a mobile phone and the like which have an arithmetic operation ability by including memory means and micro processors can be used as the gift certificate issuer terminal device 110 according to the present invention. The gift certificate issuer terminal device 110 may also further include a user interface providing module (not shown) which allows the owner of the gift certificate issuer to access the gift certificate distribution system 120 and perform various functions.

The gift certificate distribution system 120 according to the one embodiment of the present invention receives various gift certificates from the gift certificate issuer terminal device 110 and provides the gift certificates to the user mobile terminal 160. Also, the gift certificate distribution system 120 performs payment for the gift certificate purchase by the user mobile terminal 160 which has received the gift certificate.

According to the one embodiment of the present invention, when a user purchases a gift certificate at an affiliate, the gift certificate distribution system 120 receives goods purchase information from the user mobile terminal 160. The gift certificate distribution system 120 also receives information on an identifier recognized by the user mobile terminal 160. Here, the gift certificate distribution system 120 may further receive identifier information of the user mobile terminal 160 or identifier information of an application, which makes it possible to identify the user mobile terminal 160. The gift certificate distribution system 120 calculates a remaining amount of the gift certificate of the user on the basis of the received information. Specifically, the gift certificate distribution system 120 continuously manages the gift certificate by calculating the payment amount for the goods purchase from the current value of the gift certificate of the user. Here, the calculation may be performed by using a mileage and the like instead of the value amount of the gift certificate. The calculation information may be transmitted to the user. Also, prior to the calculation, a payment due amount is transmitted once more to the user mobile terminal 160 and the user is able to confirm the payment due amount.

Meanwhile, according to another embodiment of the present invention, the gift certificate distribution system 120 may send the affiliate terminal device 140 payment due information based on the goods purchase information received from the user mobile terminal 160. An affiliate owner requests payment approval after confirming the information, the gift certificate distribution system 120 completes the payment based on the payment information.

According to the one embodiment of the present invention, in identifier recognition information received from the user mobile terminal 160, the identifier may be an identifier which is disposed in an affiliate or may be an identifier which is outputted by inputting the goods purchase information to the affiliate terminal device 140. The identifier may be outputted to a display device 141 connected to the affiliate terminal device 140. The display device 141 may be implemented with a monitor of a signature pad and the like, or may be implemented as one component included in the affiliate terminal device 140.

In the mean time, according to the another embodiment of the present invention, a user is able to purchase goods by visiting an online shopping mall through the user terminal device 150 connected to the communication network 100. Here, when the user purchases and requests payment for goods at the online shopping mall, an identifier may be displayed on a display unit of the user terminal device 150 on the basis of the corresponding goods purchase information. As such, the identified recognized by the user mobile terminal 160 may be the identifier which is displayed on the user terminal device 150.

After the payment is completed, final payment completion information may be transmitted to the affiliate terminal device 140 through the VAN server 130.

The VAN server 130 according to the one embodiment of the present invention performs a function to relays communication between the gift certificate distribution system 120 and the affiliate terminal device 140. As described above, the payment completion information transmitted from the gift certificate distribution system 120 may be transmitted to the affiliate terminal device 140 through the VAN server 130. The payment approval request transmitted from the affiliate terminal device 140 may be also transmitted to the gift certificate distribution system 120 through the VAN server 130. For convenience of description, it is mentioned that the gift certificate distribution system 120 and the VAN server 130 are different from each other. However, the gift certificate distribution system 120 and the VAN server 130 may be included in the same system or the same server, or may be implemented as one system or one server.

The affiliate terminal device 140 according to the one embodiment of the present invention may be a point of sale (POS) terminal that is a common payment terminal device, a credit authorization terminal (CAT) or an Europay, Master, Visa (EMV) terminal, etc., or may be another kind of a payment terminal device.

The affiliate terminal device 140 according to the one embodiment of the present invention outputs a receipt based on the payment information transmitted from the gift certificate distribution system 120. A payment approval request, a payment cancel request or the like of the owner of the affiliate who has confirmed the payment information transmitted from the gift certificate distribution system 120 is also transmitted to the gift certificate distribution system 120 by the affiliate terminal device 140. Meanwhile, according to the another embodiment of the present invention, the affiliate terminal device 140 may display the identifier on the display device 141 on the basis of the inputted goods purchase information.

The affiliate terminal device 140 enables the affiliate owner to request the payment approval or the payment cancel and is able to provide a user interface allowing the affiliate owner to input the goods purchase information. The affiliate owner may input the payment information to the affiliate terminal device 140 by pressing a “gift certificate payment key” through the user interface in order to be distinguished from a normal payment process.

The affiliate including the affiliate terminal device 140 according to the one embodiment of the present invention may have a unique identifier. The affiliate identifier may be attached to the affiliate terminal device 140 or may be disposed in other positions so that the affiliate or the affiliate terminal device 140 can be identified.

The identifier may have, for example, a one or two dimensional bar code type. The identifier may be a radio frequency identification (RFID) tag, a near field communication (NFC) tag or may be recognizable in a wireless manner different from those above. Further, as described above, the identifier displayed on either the display device 141 or the display unit of the user terminal device 150 may also have the same type as mentioned above.

The identifier may include information on the affiliate, for example, an affiliate code, an affiliate location, an affiliate name and the like. Both the identifier which is displayed at the time of inputting the goods purchase information to the affiliate terminal device 140 and the identifier which is displayed on the display unit of the user terminal device 150 may include goods purchase information as well as the information on the affiliate.

The user terminal device 150 according to the one embodiment of the present invention is connected to the communication network 100 and allows the user to use the online shopping mall. As described above, when the user purchases goods at the online shopping mall, the identifier may be displayed on the display unit of the user terminal device 150 on the basis of the corresponding goods purchase information. The user terminal device 150 according to the one embodiment of the present invention may be a personal computer (e.g., a desk top computer, a notebook computer, etc.), a workstation, a PDA, a web pad, a mobile phone and the like. Additionally, while the user terminal device 150 and the user mobile terminal 160 are described as separate components, the user terminal device 150 and the user mobile terminal 160 may be the same components. For example, the user may purchase goods through the user mobile terminal 160 at the online shopping mall and may transmit the identifier information as it is displayed on the user mobile terminal 160 on the basis of the goods purchase information to the gift certificate distribution system 120.

The user mobile terminal 160 according to the one embodiment of the present invention enables the user to search and purchase a gift certificate. The user mobile terminal 160 may include an application making it possible to recognize the identifier and transmit the recognized information when the user purchases goods at an affiliate. The application may be provided and installed by the gift certificate issuer or a gift certificate manager.

The user mobile terminal 160 according to the one embodiment of the present invention may include a predetermined identifier recognizer 164. The user mobile terminal 160 transmits information on the recognized identifier and the goods purchase information to the gift certificate distribution system 120. The payment completion information transmitted from the gift certificate distribution system 120 may be transmitted to the user mobile terminal 160.

The user mobile terminal 160 according to the one embodiment of the present invention is a digital device allowing the user to access and then communicate with the gift certificate distribution system 120. Any digital device, such as a personal computer (e.g., a desk top computer, a notebook computer, etc.), a workstation, a PDA, a web pad, a mobile phone and the like which have an arithmetic operation ability by including memory means and micro processors can be used as the user mobile terminal 160 according to the present invention.

Hereafter, the detailed configuration and operation of the gift certificate distribution system 120 which is a main characteristic component of the present invention will be described in detail.

### Gift Certificate Distribution System

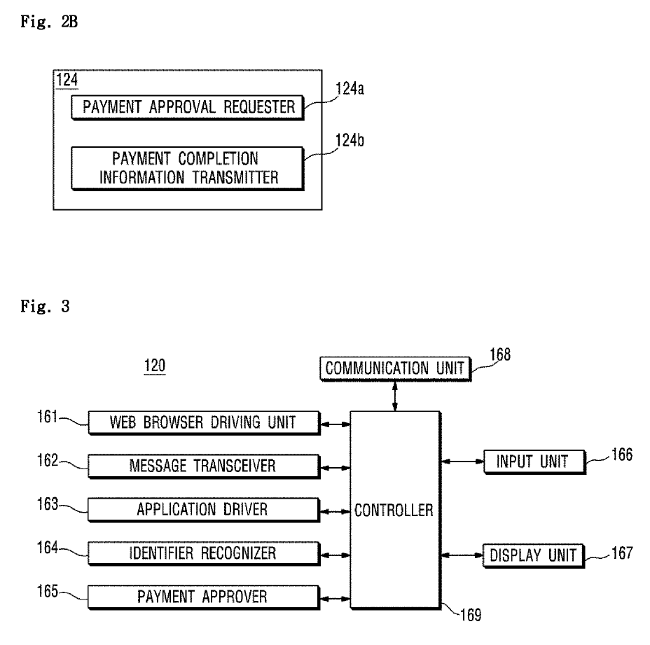

FIG. 2a is a view showing a detailed configuration of the gift certificate distribution system 120 according to the one embodiment of the present invention.

As shown in FIG. 2a, the gift certificate distribution system 120 of the present invention may include a gift certificate seller 121, an identifier information receiver 122, a payment information receiver 123, a payment performer 124, a gift certificate manager 125, a gift certificate database 126, an affiliate identifier database 127, a communication unit 128 and a controller 129.

According to the one embodiment of the present invention, at least some of the gift certificate seller 121, the identifier information receiver 122, the payment information receiver 123, the payment performer 124, the gift certificate manager 125, the gift certificate database 126, the affiliate identifier database 127, the communication unit 128 and the controller 129 may be program modules communicating with the gift certificate issuer terminal device 110, the affiliate terminal device 140 or the user mobile terminal 160. The program modules may be included in the gift certificate distribution system 120 in the forms of an operating system, application program modules and other program modules, and may be physically stored in various well-known storage devices. Also, the program modules may be stored in a remote storage device capable of communicating with the gift certificate distribution system 120. Meanwhile, the program modules include a routine, a subroutine, a program, an object, a component, a data structure and the like all of which either perform a particular task to be described below or implement a particular abstract data type in accordance with the present invention. The program modules may also include others without limitation.

First, the gift certificate seller 121 performs a function of selling a gift certificate provided from the at least one gift certificate issuer terminal device 110 to a user. As described above, through either web search or search by using applications, the user is able to search and purchase the gift certificate handled by the gift certificate distribution system 120. The gift certificate seller 121 may provide information on the gift certificate to be handled (a sort of the gift certificate, an issuer of the gift certificate, a price of the gift certificate, and the like) to the user mobile terminal 160. When the gift certificate seller 121 receives a purchase request for a particular gift certificate from the user mobile terminal 160, the gift certificate seller 121 provides a payment information input window for the gift certificate purchase. When the user selects a payment type and inputs the payment information to the payment information input window, a separate payment server (for example, a credit card company's server and the like) transmits the payment completion information to the gift certificate distribution system 120, and then the gift certificate seller 121 checks that the payment is completed.

The gift certificate seller 121 may transmit a gift certificate purchase completion message to the user mobile terminal 160. The purchase completion message may include link information on a web page providing a download of an application corresponding to that gift certificate. Through the link information included in the purchase completion message, the user who has received the purchase completion message moves to the web page enabling the user to download the application, and then downloads and installs that application. Meanwhile, after the payment for the gift certificate is completed, the gift certificate seller 121 may receive identification information of the user mobile terminal 160 to which the purchase completion message will be transmitted. For this purpose, the gift certificate seller 121 may provide an input window allowing the identification information to be inputted. The user may input the identification information on his/her mobile terminal 160 or the identification information on the mobile terminal 160 of another user. By the input of the identification information on the mobile terminal 160 of another user, the user may give the gift certificate purchased by himself or herself to the another user as a gift. The identification information of the user mobile terminal 160 may be a telephone number.

When the user moves to a predetermined web page through the link information included in the purchase completion message, the application may be transmitted from the gift certificate seller 121 to the user mobile terminal 160. The application performs a function of both activating the identifier recognizer 164 of the user mobile terminal 160 in order that the user mobile terminal 160 recognizes and transmits the identifier, and transmitting information on the recognized identifier to the gift certificate distribution system 120. The application may also allow the user to search and purchase a gift certificate. The application may allow the user to confirm payment due information prior to a final payment performed by the gift certificate distribution system 120, and then may allow the user to input payment approval information with respect to the payment due information. For example, the user may transmit a payment approval intention to the gift certificate distribution system 120 by pressing a “payment approval” button displayed through the application. The applications may be different according to the sort of the gift certificate. Each of the application may include a unique identifier. The gift certificate distribution system 120 which has received the application identifier as well as affiliate identifier information from the user mobile terminal 160 may identify the user mobile terminal 160 which has transmitted information corresponding to the application identifier.

According to the one embodiment of the present invention, the gift certificate seller 121 causes the information on the gift certificate, which has been purchased by the user or received as a gift from another user, to correspond to the information on the identifier of the user mobile terminal 160 of that user and stores in the gift certificate database 126.

The identifier information receiver 122 according to the one embodiment of the present invention receives the identifier recognition information from the user mobile terminal 160. The identifier information receiver 122 may also receive identification information on the user mobile terminal 160 which has transmitted the identifier recognition information. The identification information of the user mobile terminal 160 may be either unique identification information of the user mobile terminal 160 (for example, a telephone number, etc.) or the application identifier information. The identifier may include either affiliate identification information or goods purchase information or may include both of them.

The payment information receiver 123 according to the one embodiment of the present invention receives the goods purchase information of the affiliate from the user mobile terminal 160. The goods purchase information may include information on goods to be purchased (for example, a kind of an article, a name of an article, an amount to be purchased, and the like) or a value amount to be paid. Such information may be inputted and transmitted through an application driven by the user mobile terminal 160. The information is inputted by a purchaser or the affiliate owner.

According to the another embodiment of the present invention, the identifier recognized by the user mobile terminal 160 may include not only the information on the affiliate but also article purchase information. For example, the article purchase information may be included in either an identifier outputted to the display device 141 by the goods purchase information input through the affiliate terminal device 140 or an identifier outputted to the display unit of the user terminal device 150. In such a case, a separate payment information reception by the payment information receiver 123 may be omitted and only the identifier recognition information reception by the identifier information receiver 122 may be performed.

The payment performer 124 according to the one embodiment of the present invention completes the payment on the basis of the information transmitted from the identifier information receiver 122 or the payment information receiver 123.

Referring to FIG. 2b, the payment performer 124 may include a payment approval requester 124a and a payment completion information transmitter 124b.

On the basis of the received information, the payment approval requester 124a may transmit the payment due information to the affiliate terminal device 140 or the user mobile terminal 160. An affiliate can be identified and the goods purchase information can be recognized on the basis of the identifier recognition information transmitted from the user mobile terminal 160. The user can be also identified on the basis of the identification information of the user mobile terminal 160 (for example, a telephone number and the like). The affiliate owner confirms the payment due information transmitted to the affiliate terminal device 140 and then is able to request a payment approval or a payment cancel. The user confirms the payment due information transmitted to the user mobile terminal 160 and then is able to request a payment approval or a payment cancel. Such processes may be omitted.

The payment approval requester 124a makes reference to the gift certificate database 126 and compares a remaining amount of a gift certificate of that user, that is, a gift certificate corresponding to the identifier information of the application which is now run by the user mobile terminal 160 with a current payment amount. If the remaining amount of the gift certificate is relatively less than the current payment amount, the corresponding information may be transmitted to the user mobile terminal 160. For example, a warning notifying that the payment cannot be done due to the shortage of the remaining amount may be transmitted to the user mobile terminal 160. Also, a user is induced to purchase the gift certificate by transmitting information on a recommendation gift certificate and the like to the user mobile terminal 160. If the remaining amount of the gift certificate is sufficient, the user confirms the payment information displayed on the user mobile terminal 160 and checks whether or not information on the articles that the user has purchased and on services that the user has used is equal to the payment amount and then approves the payment. For example, a window asking whether the payment is approved or not is displayed on a gift certificate application run by the user mobile terminal 160. Then, the user approves the payment by pressing a “payment approval” button.

The payment completion information transmitter 124b may transmit the information on the payment completion to the affiliate terminal device 140 or the user mobile terminal 160. The affiliate terminal device 140 may output a receipt on the basis of that payment completion information.

After the payment is completed, the gift certificate manager 125 according to the one embodiment of the present invention updates the information of the gift certificate database 126 by subtracting the current payment amount from the remaining amount of the gift certificate corresponding to the identifier information of the gift certificate application which that user has used for the purchase of the goods, and then provides the updated information to the user mobile terminal 160. Otherwise, the gift certificate manager 125 may subtract the mileage used for the current payment from a current remaining mileage. The mileage may be accumulated when the user purchases goods at an affiliate or may be obtained without a separate purchase process. Through these processes, the user is able to confirm the information on gift certificates owned by himself/herself, the remaining amount or the remaining mileage of the gift certificate. If the remaining amount of the gift certificate is less than a predetermined amount, the gift certificate manager 125 transmits a warning message to the user mobile terminal 160 or provides information encouraging the user to purchase additional gift certificates (for example, gift certificate recommendation information and the like).

The communication unit 128 according to the one embodiment of the present invention receives the identifier recognition information and the article purchase information, and transmits the payment completion information to the affiliate terminal device 140. On the whole, the communication unit 128 may perform a function of allowing the gift certificate distribution system 120 according to the present invention to communicate with external devices such as the affiliate terminal device 140, the user mobile terminal 160 and the like.

The controller 129 according to the one embodiment of the present invention may control data flows among the gift certificate seller 121, the identifier information receiver 122, the payment information receiver 123, the payment performer 124, the gift certificate manager 125, the gift certificate database 126, the affiliate identifier database 127 and the communication unit 128. In other words, the controller 129 according to the present invention controls each of the gift certificate seller 121, the identifier information receiver 122, the payment information receiver 123, the payment performer 124, the gift certificate manager 125, the gift certificate database 126, the affiliate identifier database 127 and the communication unit 128 to perform a unique function by controlling the data flows among the components of the gift certificate distribution system 120.

Hereafter, the detailed configuration and operation of the user mobile terminal according to the one embodiment of the present invention will be described in detail.

### User Terminal Device

FIG. 3 is a view showing a detailed configuration of a user terminal device according to the one embodiment of the present invention.

As shown in FIG. 3, the user mobile terminal 160 of the present invention may include a web browser driving unit 161, a message transceiver 162, an application driver 163, an identifier recognizer 164, a payment approver 165, an input unit 166, a display unit 167, a communication unit 168 and a controller 169.

According to the one embodiment of the present invention, at least some of the web browser driving unit 161, the message transceiver 162, the application driver 163, the identifier recognizer 164, the payment approver 165, the input unit 166, the display unit 167, the communication unit 168 and the controller 169 may be program modules communicating with the gift certificate distribution system 120. The program modules may be included in the user mobile terminal 160 in the forms of an operating system, application program modules and other program modules, and may be physically stored in various well-known storage devices. Also, the program modules may be stored in a remote storage device capable of communicating with the user mobile terminal 160. Meanwhile, the program modules include a routine, a subroutine, a program, an object, a component, a data structure and the like all of which either perform a particular task to be described below or implement a particular abstract data type in accordance with the present invention. The program modules may also include others without limitation.

The user mobile terminal 160 allows the user to search gift certificates through a variety of methods and to purchase the searched gift certificate.

According to the one embodiment of the present invention, a user may search and purchase a gift certificate by searching a web through a web browser driven by the web browser driving unit 161. For example, the user may search a gift certificate by inputting predetermined keywords (for example, “a convenience store gift certificate”, “a coffee shop gift certificate” or the like) to a predetermined portal site and purchase the searched gift certificate. When the user requests the purchase of a predetermined gift certificate, the gift certificate distribution system 120 provides the user mobile terminal 160 with a payment information input window for the payment of purchased gift certificate. Through the payment information input window, the user inputs the payment information and purchases the gift certificate. For example, the gift certificate distribution system 120 may provide a credit card information input window and the user may perform payment by inputting the credit card information. Here, a credit card company's server (not shown) transmits the information on the payment approval to the gift certificate distribution system 120, and thereby the gift certificate purchase is completed. However, according to the another embodiment of the present invention, the user may search and purchase the gift certificate by means of a predetermined gift certificate search application run by the application driver 163. The application may be provided by the gift certificate distribution system 120 or the gift certificate issuer terminal device 110, or may be a unique application of the user mobile terminal 160. The gift certificate payment process may be performed in the same manner as that of the gift certificate purchase through the web search.

In the mean time, according to the another embodiment of the present invention, a desired gift certificate may be searched and purchased by the web search through other terminals (e.g., a personal computer and the like) as well as the user mobile terminal 160. Otherwise, the gift certificate may be also purchased in an offline store and the like.

According to the one embodiment of the present invention, the user may visit an online shopping mall through the web browser driving unit 161 of the user mobile terminal 160 and purchase goods. When the goods are purchased, an identifier including the information on the online shopping mall may be displayed on the display unit 167, and information on that identifier is transmitted to the gift certificate distribution system 120, so that the payment is completed.

The message transceiver 162 according to the one embodiment of the present invention performs a function of receiving a purchase completion message from the gift certificate distribution system 120. The purchase completion message shows that the gift certificate has been completed. When the payment for the gift certificate purchase is completed, the gift certificate distribution system 120 receives payment approval information and transmits the purchase completion message for the gift certificate purchase to the user. The purchase completion message may be transmitted in the form of a short message service (SMS). The purchase completion message may include link information on a web page enabling applications related to the purchased gift certificates to be downloaded.

Meanwhile, through the input unit 166, the user may input the identification information (for example, a telephone number, etc.) on the user mobile terminal 160 to which the purchase completion message including the link information will be transmitted, before receiving the purchase completion message. The input identification information of the user mobile terminal 160 may be transmitted to the gift certificate distribution system 120. The gift certificate distribution system 120 may transmit the gift certificate purchase completion message to the user mobile terminal 160 corresponding to the transmitted identification information. The gift certificate purchased in such a manner described above is sent as a gift to the user mobile terminal 160 of another user. According to the one embodiment of the present invention, the user may purchase the gift certificate at an offline store and the like. The user may also purchase the gift certificate through a personal computer and the like. In this case, in accordance with a conventional method, the purchase completion message including application download link information may also be transmitted to the user mobile terminal 160 by transmitting the identification information of the user mobile terminal 160 of his/her own or another user to the gift certificate distribution system 120.

The application driver 163 according to the one embodiment of the present invention drives an application corresponding to the gift certificate purchased by the user. When the purchase completion message is transmitted to the user mobile terminal 160, the user is able to move based on the link information included in the purchase completion message to a web page providing a download of an application required to use the gift certificate, and able to download the application from the web page and install in the user mobile terminal 160. The application may be provided by the gift certificate distribution system 120. As described above, an application corresponding to each gift certificate may include a unique identifier. The identifier may identify not only the application but also the user mobile terminal 160.

The identifier recognizer 164 according to the one embodiment of the present invention performs a function of recognizing an identifier including information on the affiliate or goods purchase information. When the identifier has a one or two dimensional bar code type, a camera module and the like capable of photographing the bar code may function as the identifier recognizer 164. Meanwhile, when the affiliate identifier has an RFID tag type, the identifier recognizer 164 may be an RFID reader. When affiliate identifier has a NFC tag type, the identifier recognizer 164 may be an NFC chip and the like. An identifier having a type different from those mentioned above may be used. The identifier recognizer 164 may be various types of modules capable of recognizing a corresponding identifier.

When the user visits an affiliate and runs an application related to a gift certificate to be used, the application driver 163 drives the application. Here, the identifier recognizer 164 may be activated. When an identifier is recognized by the identifier recognizer 164, the application causes the information on the recognized identifier to be transmitted to the gift certificate distribution system 120. Here, the application may also transmit unique identifier information of the application to the gift certificate distribution system 120. As a result, the gift certificate distribution system 120 is able to recognize not only the user who has transmitted the information on the affiliate identifier, but also the user mobile terminal 160 of the user. The identifier which has been recognized by the identifier recognizer 164 may be displayed on the display unit 167.

The payment approver 165 according to the one embodiment of the present invention receives not only information on the value amount to be currently paid by the user, but also the payment approval request from the gift certificate distribution system 120. The payment approver 165 performs a function of transmitting again an approval request or a cancel request for the payment due information, which is transmitted from the gift certificate distribution system 120, to the gift certificate distribution system 120. Such a function or an operation may be omitted.

The communication unit 168 according to the one embodiment of the present invention may perform a function of allowing the gift certificate distribution system 120 and the user mobile terminal 160 to communicate with each other.

The controller 169 according to the one embodiment of the present invention may control data flows among the web browser driving unit 161, the message transceiver 162, the application driver 163, the identifier recognizer 164, the payment approver 165, the input unit 166, the display unit 167 and the communication unit 168. That is to say, the controller 169 according to the present invention controls each of the web browser driving unit 161, the message transceiver 162, the application driver 163, the identifier recognizer 164, the payment approver 165, the input unit 166, the display unit 167 and the communication unit 168 to perform a unique function by controlling the data flows among the components of the user mobile terminal 160.

The foregoing embodiments of the present invention may be implemented in the form of a program instruction which is executable by various computer components and may be recorded in a computer-readable recording medium. The computer-readable recording medium may include program instructions, data files, data structures and the like separately or in a combination thereof. The program instructions recorded in the computer-readable recording medium may be specially designed and configured for the purpose of the present invention or may be well-known and available to those skilled in the field of computer software. A magnetic medium such as a hard disk, a floppy disk and a magnetic disk, an optical recording medium such as a CD-ROM and DVD, a magnetic-optical medium such as a floptical disk, and a hardware device such as ROM, RAM, a flash memory and the like, which is specially configured to store and run program instructions are included as examples of the computer-readable recording medium. Not only a machine language code which is formed by a complier but also high-level language code which can be executed by a computer using an interpreter are included as examples of the program instruction. The hardware device may be configured to operate as one or more software modules in order to perform the processes according to the present invention, and vice versa.

While the present invention has been described with reference to the specific features such as detailed components and the like, specific embodiments and drawings, these are given only for providing the general understanding of the present invention. The present invention is not limited to the embodiments described above, and it can be understood by those skilled in the art that various modifications and variations can be made from those described herein.

Therefore, it should be noted that the spirit of the present invention is not limited to the embodiments described above and the appended claims and any variations equivalent thereto are included in the scope and spirit of the present invention.

What is claimed is:

1. A method for distributing a gift certificate, the method comprising:
(a) receiving recognition information on an identifier, which includes affiliate identification information or goods purchase information, from a user mobile terminal;
(b) performing payment on the basis of the received information; and
(c) transmitting payment completion information to the user mobile terminal or an affiliate terminal device.

2. The method of claim 1, wherein the identifier is generated and displayed in response to the goods purchase information inputted through the affiliate terminal device.

3. The method of claim 1, wherein the identifier is generated and displayed in response to the goods purchase information at an online shopping mall visited through the user terminal device.

4. The method of claim 1, wherein the step (b) comprises:
transmitting payment due information based on the received information to the user mobile terminal or the affiliate terminal device;
receiving a payment approval request or a payment cancel request from the user mobile terminal or the affiliate terminal device; and
completing the payment based on the payment due information when the payment approval request is received from the user mobile terminal or the affiliate terminal device.

5. The method of claim 4, wherein the completing the payment comprises calculating a remaining amount of the gift certificate of the user or a mileage of the user on the basis of the payment information.

6. The method of claim 1, before step (a), further comprising:
receiving a purchase request for the gift certificate from the user mobile terminal;
performing payment for the gift certificate requested to be purchased;
transmitting an application corresponding to the gift certificate to the user mobile terminal.

7. The method of claim 6, wherein the application makes it possible to recognize the identifier and transmit the recognized information.

8. The method of claim 1, wherein the identifier has at least one of a one dimensional bar code type, a two dimensional bar code type, a radio frequency identification (RFID) tag or a near field communication (NFC) tag.

9. A gift certificate distribution system comprising:
an identifier information receiver receiving recognition information on an identifier, which includes affiliate identification information or goods purchase information, from a user mobile terminal; and
a payment performer performing payment on the basis of the received information and transmitting payment completion information to the user mobile terminal or an affiliate terminal device.

10. The gift certificate distribution system of claim 9, wherein the identifier is generated and displayed in response to the goods purchase information inputted through the affiliate terminal device.

11. The gift certificate distribution system of claim 9, wherein the identifier is generated and displayed in response to the goods purchase information at an online shopping mall visited through the user terminal device.

12. The gift certificate distribution system of claim 9, wherein the payment performer comprises:
a payment approval requester which transmits payment due information based on the received information to the affiliate terminal device; and
a payment completion transmitter which receives a payment approval request from the affiliate terminal device, completes the payment based on the payment due information, and transmits payment completion information to the affiliate terminal device or the user mobile terminal.

13. The gift certificate distribution system of claim 9, wherein the payment performer comprises calculating a remaining amount of the gift certificate of the user or a mileage of the user on the basis of the payment information.

14. The gift certificate distribution system of claim 9, further comprising a gift certificate seller which receives a purchase request for the gift certificate from the user mobile terminal, performs payment for the gift certificate requested to be purchased, and transmits an application corresponding to the gift certificate to the user mobile terminal.

15. The gift certificate distribution system of claim 14, wherein the application makes it possible to recognize the identifier and transmit the recognized information.

16. The gift certificate distribution system of claim 9, wherein the identifier has at least one of a one dimensional bar code type, a two dimensional bar code type, a radio frequency identification (RFID) tag or a near field communication (NFC) tag.

17. A mobile terminal comprising:
an identifier recognizer which recognizes an identifier including affiliate identification information or goods purchase information and transmits the recognized information; and
an application driver which activates the identifier recognizer and drives an application completing payment based on the transmitted information.

18. The mobile terminal of claim 17, wherein the identifier recognizer is implemented by at least one of a camera module, an RFID reader and an NFC chip.

19. A computer-readable recording medium which records a computer program for executing a method according to claim 1.
